(19) United States
(12) Patent Application Publication
(10) Pub. No.: US 2011/0001677 A1
(43) Pub. Date: Jan. 6, 2011

(54) STEREO FED DIGITAL ANTENNA

(76) Inventor: Richard Strnad, Plano, TX (US)

Correspondence Address: WILSON DANIEL SWAYZE, JR., 3804 CLEARWATER CT., PLANO, TX, 75025, US

(21) Appl. No.: 12/497,276

(22) Filed: Jul. 2, 2009

(51) Int. Cl. H01Q 9/16

(52) U.S. Cl. 343/793

(57) ABSTRACT

A directional communication antenna comprising a conductive member connected to transmitter power amplifiers or receiver input amplifiers is provided. The simplest antenna form includes a conductor connected to a pair of transmitter power amplifiers or a pair of receiver input amplifiers. Antenna in the transmitter mode is connected to a pair of power amplifiers sending synchronized rf signals to the ends of a conductor. Applied signals travel and collide on antenna where they are converted into the free-space wave. In the receiving mode, two or more receiver input amplifiers are connected to detect and amplify incoming signals. The incoming signals are then electronically added for improved sensitivity.

### BACKGROUND OF THE INVENTION

1. Field of the Invention

Generally, the present invention relates to a stereo fed digital antenna used in combination with devices for point to point communication, general communication and for a directional point to point transfer of electrical energy.

2. Description of the Prior Art

The basic antenna, although 123 year old, has not changed in structure, but in electronics, it is a unique phenomenon. Perhaps, it is the only device of such birthday that has not changed. It may be due to the fact that the antenna design is the least understood and includes complicated aspects of RF transmitter station design process. With so many interdependent variables application, the design may be as much art as science. Many scientists will say that when it comes to designing the length of an antenna for example, the best procedure is to first perform calculations with computer simulations and then build one and try out the antenna performance and expect deviations from your calculations. The most reliable design technique of the antenna is the old cut-and-try method. Fortunately, enormous amounts of empirical data with the test results are available on the internet and will help in the design.

Nearly all antennas have been developed from two basic types, the Hertz (1886) and the Marconi. The basic Hertz antenna is ½ wavelength long at the operating frequency and is insulated from ground. It is often called a dipole or a doublet. The basic Marconi antenna is ¼ wavelength long and is either grounded at one end or connected to a network of wires called a counterpoise. The ground or counterpoise provides the equivalent of an additional ¼ wavelength, which is required for the antenna to resonate.

Heinrich Rudolf Hertz (1857-1894), German physicist, was born at Hamburg. He studied physics under Helmholtz in Berlin, at whose suggestion he first became interested in Maxwell's electromagnetic theory. His researches with electromagnetic waves which made his name famous were carried out at Karlshruhe Polytechnic between 1885-1889.

The antenna is a passive device and it is grouped into two categories. The first category are antennas with open-ended wires, is characterized as the standing wave antennas or resonant antennas. The current on these antennas can be written as a sum of waves traveling in opposite directions, incidental waves traveling directly into antenna from RF power amplifier and the waves reflected at the open end traveling in the opposite direction. The incidental and reflected waves of opposite polarities collide and are converted into free-space wave. A point on the antenna, where the incidental and reflected waves meet is the point of the highest free-wave emission.

The second category of antennas is the traveling wave antenna characterized by matched terminations so that the current is defined in terms of waves traveling only in one direction. Examples of traveling wave antennas are Rhombic and Vee antennas. These antennas are directive and are usually several wavelengths long. Both standing wave and the traveling wave antennas require that the contour of the waveform represents a full and closed 360° cycle in order to transmit undistorted signals. Especially the resonant antennas are sensitive to signals with smaller than 360° phase angles. Resonant antennas can not truly emit signals that are not of a periodic character, such as the wave pockets with amplitudes very small or single signals, such as pulses.

Earth surface antennas used in wireless telecommunication systems have the capability to transmit and receive electromagnetic RF signals. Received signals are processed by a receiver at the base station and fed into a communications networks.

Due to the increasing number of base station antennas, manufacturers are attempting to minimize the size of each antenna and reduce manufacturing cost. Moreover, the visual and physiological impact of base station antenna towers on communities has become a social concern. Thus, it is desirable to reduce the size of these towers and thereby lessen the visual and physiological impact of the towers on the community. The size of the towers and the transmitter power can be reduced by using smaller base station antennas and by using highly directional antennas.

There is also a need for an antenna with wide impedance bandwidth which displays a stable far-field pattern across that bandwidth. There is also a need for increasing the bandwidth of existing single-polarization antennas so they can operate in the cellular, Global System for Mobile (GSM), Personal Communication System (PCS), Personal Communication Network (PCN), and Universal Mobile Telecommunications Systems (UMTS) frequency bands.

There may also be developed a need for an antenna that will render possible transmission of high power RF energy. If such an antenna is realized, the need for wired grid network may be reduced with collateral benefits such as low cost with easy distribution.

U.S. PATENT DOCUMENTS

| | | | |
|---|---|---|---|
| 3,406,398 | October 1968 | Beguin | 343/786 |
| 3,831,176 | August 1974 | Epis at al | 343/756 |
| 4,217,549 | August 1980 | Henoch | 343/78.6 X |
| 4,266,203 | May 1981 | Saudreau et al | 343/786 X |
| 4,320,404 | March 1982 | Chekroun | 343/786 X |
| 4,571,593 | February 1086 | Martinson | 343/786 X |
| 4,630,059 | December 1986 | Maz | 343/786 X |
| 4,633,264 | December 1986 | Imazeki et al. | 343/786 |

### SUMMARY OF THE INVENTION

An antenna system for transmitting a signal may include a traveling wave antenna having a first conductor and a second conductor, the first conductor being positioned at an acute angle with respect to the second conductor, and a transmission line coupled to the first conductor and the second conductor.

An antenna system for transmitting a signal may include a resonant dipole antenna having a first conductor and a second conductor, the first conductor being positioned at a substantially 180° angle with respect to the second conductor, a transmission line coupled to the first conductor and the second conductor.

An antenna system for transmitting a signal may include the signal having a first portion and a second portion, an antenna having a first conductor and a second conductor, the first conductor being connected to receive the first portion of the signal and the second conductor being connected to receive the second portion of the signal, a first transmission line coupled to the first conductor to conduct the first portion of the signal and a second transmission line coupled to the second conductor to conduct the second portion of the signal. The first conductor is connected to the second conductor at a substantial center point of the first conductor and the second conductor.

### BRIEF DESCRIPTION OF THE DRAWINGS

Various features of this invention will become fully appreciated as the same becomes better understood when considered in conjunction with the accompanying drawings in which:

FIG. 1 is a drawing of a standing-wave resonant half-wave dipole antenna with a length that is one-half of the fundamental wavelength. It is broken into two quarter-wave length called elements. The elements are set at 180° from each other and fed from the middle. This type of antenna is called a center-fed half-wave dipole.

FIG. 2 is a drawing of a Vee traveling wave antenna, formed by connecting two matched traveling wave segments to the end of a transmission line feed at an angle of Q relative to each other.

FIG. 3 is a view of a resonant dipole antenna emphasizing the points of maximum current/minimum voltage with highlighted points of maximum radiation/emission at the center. To contentious lines at the center are showing the radiation of two signals of opposite polarities.

FIG. 4 shows four different waveforms. Waveforms “A” & “B” can be transmitted via the resonant antenna, however signal waveforms “C” & “D” may not be transmitted with the resonant antenna.

FIG. 5 illustrates the “Stereo Fed Digital Antenna” (SFEDA).

FIG. 6 illustrates the SFEDA (Stereo Fed Digital Antenna) together with the applied traveling sine wave signal present in the feed line.

FIG. 7 is showing the SFEDA antenna with the signal exiting the feed line and entering the actual antenna.

FIG. 8 is presenting the traveling sinusoidal wave leaving the feed line and traveling toward the center point.

FIG. 9 is showing the traveling sine charges and colliding at the center point. Colliding waves are transformed into the free space-wave leaving the antenna system. Illustrated is also a narrow circular emission pattern of the free space-wave.

FIG. 10 highlights another version of the antenna. The section on antenna where the two traveling charges meet and collide is of trumpet shape. Such arrangement will emit RF signal with discus shape.

FIG. 11 is a pictorial view of discuss shaped RF signal emitted from antenna presented in FIG. 10.

FIG. 12 is showing an alternate version of antenna shown in FIG. 10. Only a narrow slab of the disk is used and the emitted signal pattern in narrow and collimated.

FIG. 13 is highlighting one method of splitting and inverting the signal generated by the power amplifier and applying it to the antenna.

FIG. 14 is showing alternate way of producing the RF power signals which enter the antenna with opposite polarities. The polarity is induced by extending one branch of the signal transmission by half the wavelength of the applied RF power.

### DETAILED DESCRIPTION OF THE PREFERRED EMBODIMENTS

The present invention addresses the problem associated with prior antennas by providing a dual application of power to antennas. The design would exhibit controlled impedance bandwidth, it is easy to manufacture, and can be incorporated into existing antenna designs.

A stereo fed digital antenna transmitting and receiving electromagnetic signals that are not full wave signals but signals of different and constant wavelengths.

In view of the foregoing disadvantages inherent in the known types of existing antennas, the present invention provides a structure of high efficiency converting a traveling wave along conductor to a traveling free-space wave.

To attain this, the present invention comprises a straight conductor-like structure made of conductor with center section which may incorporate passive or active components. Each end of the conductor structure is connected to a wave guide or a line and both transmission lines are connected to transmitters. Traveling rf signals along the transmission lines collide or cooperate at the center of antenna and are emitted a travel in coherent manner into space.

There has thus been outlined, rather broadly, the a few features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A object of this invention is to provide a new antenna structure that will overcome the shortcomings of the prior art devices and provides controlled emission of substantially clean rf signals substantially without any harmonic and sub-harmonic or parasitic frequencies.

An object of present invention is to provide a structure of antenna that provides low cost system for controllable wireless transport of high power energy over long distance.

Another object is to provide a antenna structure that enables transport of collimated rf signals thus minimizing the power requirements in communication systems, such as cellular phones, WLAN (wireless local area network) systems, supermarket identification tags.

Another object is to provide a physically small antenna capable of transmitting efficiently a very low frequency rf signals suitable for underwater communication.

One object of this invention is its capability to transmit a signal consisting of only partial wave form, for example a sine wave consisting of only one half of a cycle (180°). This may open door to a type of communication; it may decode the secrets of navigation of migrating animals, turtles, butterflies, fishes and birds.

It is yet another object of this invention to provide an antenna for transmitting low frequency signal, well below 5 kHz, and at the same time having a low height relative to the wavelength.

It is still another object of this invention to provide an antenna system for transmission of ultra low VLF signals that offer a considerable increase in efficiency.

It is yet another object of this invention to provide an antenna which produces clean rf signal without any harmonic or sub-harmonic content.

The antenna may eventually used for wireless transfer of electrical energy.

Other objects and advantages of the present invention will become known to the reader and it is intended that these objects and advantages are within the scope of the present invention.

According to the present invention, an array of antennas may be built and provide multiple and sequential operation of several antennas in order to transmit signals with organized coding mode impossible to decipher unless an exact geometrical structure of the transmitting antenna system is known.

To the accomplishments of the above and related objects, this invention may be embodies in the form illustrated in the accompanying drawing, attention being called to the fact, however, that the drawings are illustrative only, and that changes may be made in the specific construction illustrated.

The present antenna fulfills the need for an antenna which provides high conversion emission efficiency with controlled emission direction. The antenna may be formed from a solid conductor or the antenna may be split at substantially the center and operate as two separate legs or sections, reminding the two short dipole antennas. They may be connected at the center by a capacitor, resistor, inductor or combination of these passive elements. Or they may be connected by semi-active devices, such as semiconductor diodes.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers specific goals, such as compliance with system-related and business-related constrains, which will vary from one implementation to another. Moreover, it will be appreciated that such a development effort might be complex and time-consuming, but would be within the scope of the invention.

The present invention will now be described with reference to the attached figures. Various structures, systems and devices are schematically depicted in the drawings for purposes of explanation. Nevertheless, the attached drawings are included to describe and explain illustrative examples of the present invention. The words and phrases used herein should be understood and interpreted to have a meaning consistent with the understanding of those words and phrases by those skilled in the relevant arts. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such as special definition will be expressly set forth in the specification in a definitional manner that directly and unequivocally provides the special definition for the term or phrase.

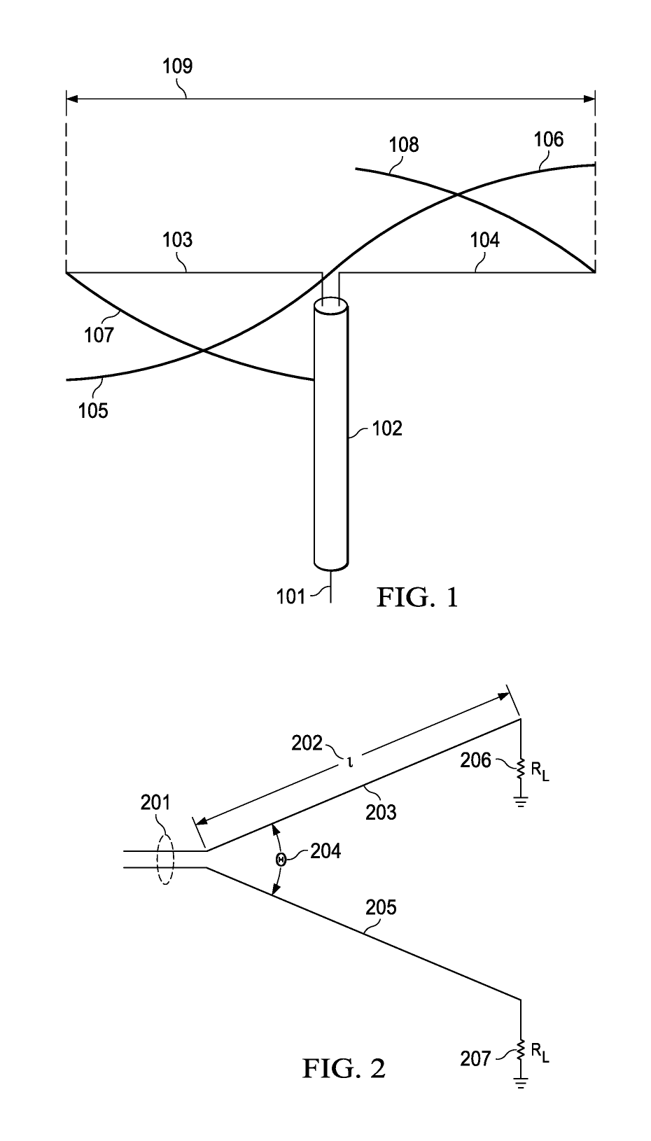

Referring to FIG. 1, a resonant dipole antenna is shown as a reference to the text. The antenna may include a feedline cable 102 where signal from the power amplifier (not shown) is applied at position 101. The feedline cable 102 may be connected to a dipole, including two wire first and second conductors 103 and 104 which may be positioned substantially opposed to each other for example the first conductor 103 may be positioned substantially 180° from the second conductor 104. The first and second conductors 103, 104 may extend from the feedline cable 102 at an angle substantially 90° from the feedline cable 102. Each of the first conductor 103 and the second conductor 104 are supplied by electrical signal from the power amplifier through the feedline cable 102. Curves 105 and 106 represent a standing wave of voltage distribution with positive and negative regions with maximums at the ends, the curves 105, 106 correspond to the signals generated by the signal being applied to the first and second conductors 101, 102, one of positive and the second of negative polarity. Curves 107 and 108 represent the positive and negative polarity current distribution and loops along the first and second conductors 103 and 104. The length of antenna is represented by the number 109, indicating that the antenna length equals to ½λ where λ is the wave length.

FIG. 2 illustrates the second category of antennas, the “traveling wave antenna”. The transmission line 201 is used to feed the antenna. Each half of the antenna 203 and 205 may be one wavelength long with wire length 202. The angle Θ 204 which may be an acute angle between the two wire conductors 203 and 205 may be dependent on the length of the wires. Both ends of antenna wire conductors 203, 205 may be terminated with resistors R_{L} which may be equal or unequal in magnitude designated as 206 and 207 and each resistor may be equal to the impedance of the antenna.

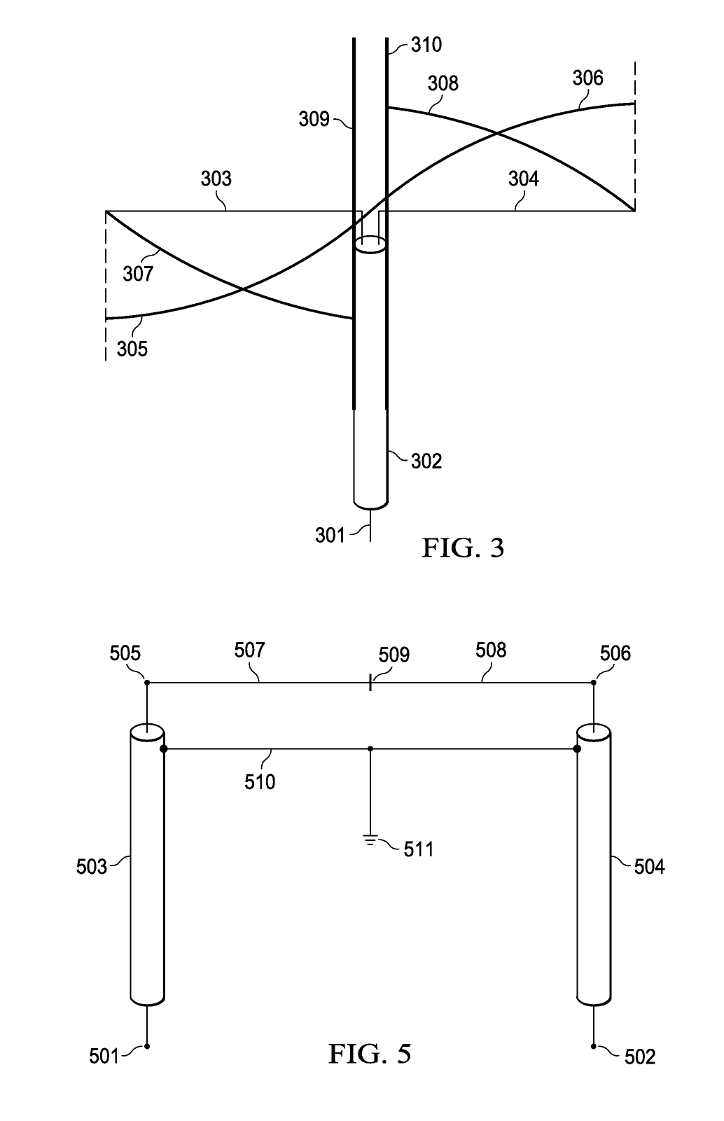

FIG. 3 illustrates the radiation pattern from a resonant dipole antenna. The RF signal from the power amplifier may be applied to the transmission line 302 at point 301 and the RF signal may be carried to two conductors 303 and 304 which may be substantially at 180°. Curves 305 and 306 represent a voltage standing wave with positive and negative regions. Curves 307 and 308 may represent the positive and negative current distribution which may be formed along the wires 303 and 304. The two lines 309 and 310 may represent the emission patterns of the two antenna branches 303 and 304.

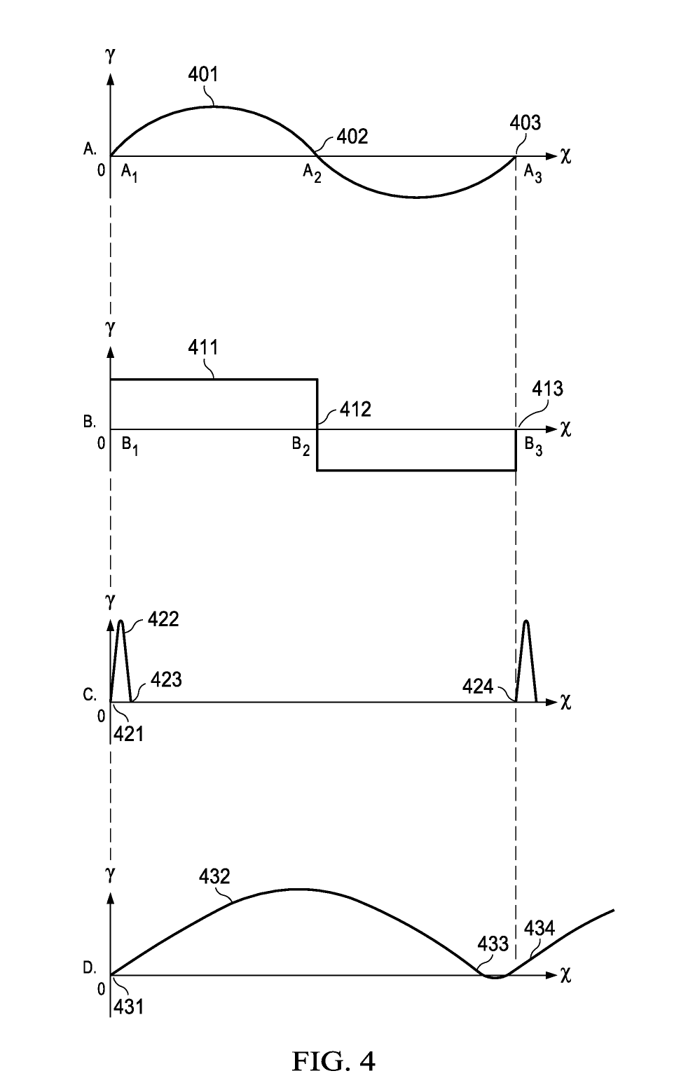

FIG. 4 shows the four types of waveforms. Waveform “A” may be a sinusoidal curve 401 with zero crossing nodes 402 and 403. Waveform “B” may be a square wave curve 401 with zero crossing nodes at 412 and 413. Waveforms “A” and “B” can be transmitted by both, the resonant and traveling wave antennas such as illustrated in FIGS. 2 and 3. Waveform “C” shows a non uniform signal 422 with zero crossing nodes 423 and 424. This signal may not be transmitted by resonant antenna. Waveform “D” is a non-symmetrical shape curve 432 which may not be transmitted via the resonant antenna. The zero crossing nodes are at points 433 and 434. All four waveforms, “A”, “B”, “C”, and “D” can be transmitted by using the stereo signal fed active antenna.

Referring to FIG. 5, the stereo fed digital antenna of the invention may include the two conductive elements 507 and 508, which may be substantially 180° disposed opposite each other as shown. Each of the conductive elements 507, 508 are connected to a independent signal generator to supply a first portion of the signal to the conductive element 507 and a second portion of the signal to the conductive element 508. Point 509 in the substantial middle which may be where the first conductive elements 507 is connected to the second conductive elements 508 and may be the point where the arriving charges of opposite polarities collide or cooperate and where the transformation of traveling wave to the free space wave occurs.

The antenna of the invention may receive two signals of opposite polarities at points 505 and 506 at which the antenna may be connected to two transmission lines 503 and 504 connected to a common ground 511 with wire 510 and may be at the substantially center of the wire 510. The two signals from power amplifiers may be connected to transmission lines 503 and 504 at points 501 and 502.

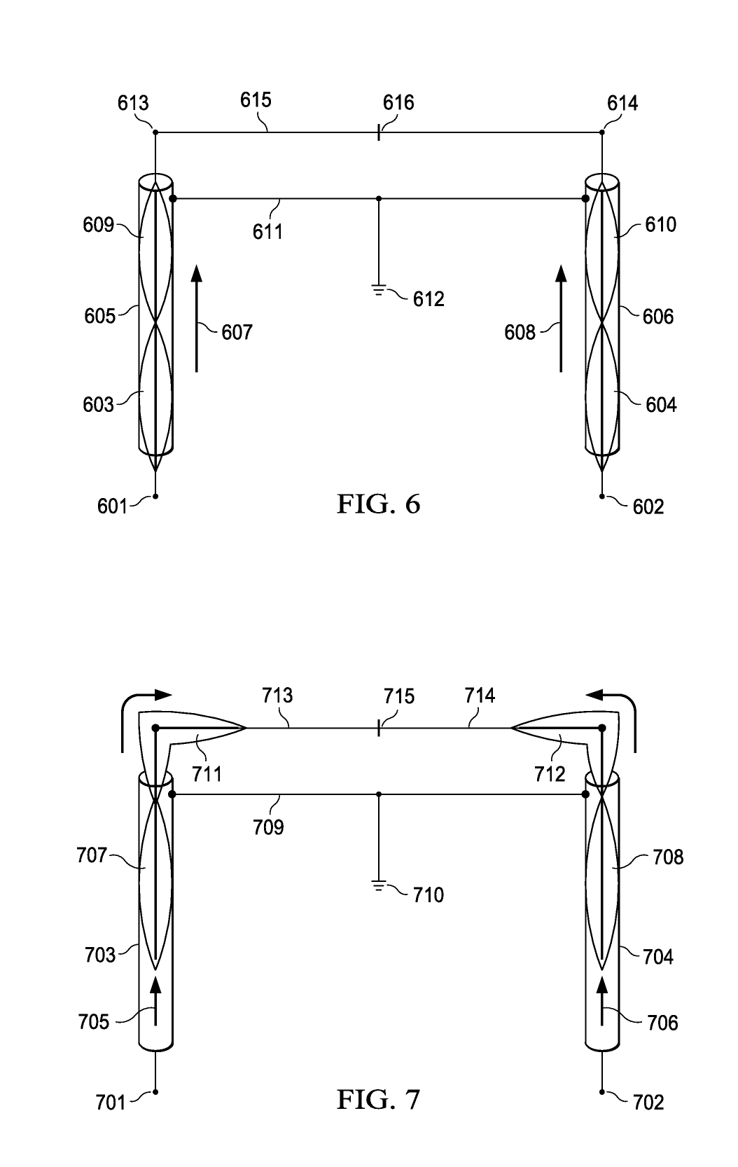

FIG. 6 shows the presence of sine-wave charges being conducted in the transmission lines 605 and 606. The RF signals may be of substantial opposite polarities applied to the transmission lines at points 601 and 602 traveling in the directions 607 and 608. The sine-wave shaped traveling charges of one polarity may occupy positions 604 and 609 at substantially the same time t₀ in the transmission lines and also the sine-wave shaped traveling charges of opposite polarity occupy positions 603 and 610 at substantially the same time t₀ in the transmission lines. Wire 611 may connect the transmission lines to the ground 612. Connection points 613 and 614 connect the transmission lines to antenna wire 615 with the substantially center recombination point 616.

FIG. 7 shows the progression of moving sine-wave charges in the transmission line towards the stereo signal fed digital antenna. The position of sinusoidal traveling charges in this pictorial view is shown at t₁=t₀+Δtₐ. Stereo signals entering at contacts 701 and 702 travel in directions 705 and 706 in transmission lines 703 and 704. At the time t₁ sine-wave charges of opposite polarities 711 and 712 entered the stereo signal fed active antenna sections 713 and 714 and they travel toward the center 715. The second halves of the sine wave charges of opposite polarities are shown as 707 and 708. The ground wire 709 is connecting both transmission lines to the ground at 710.

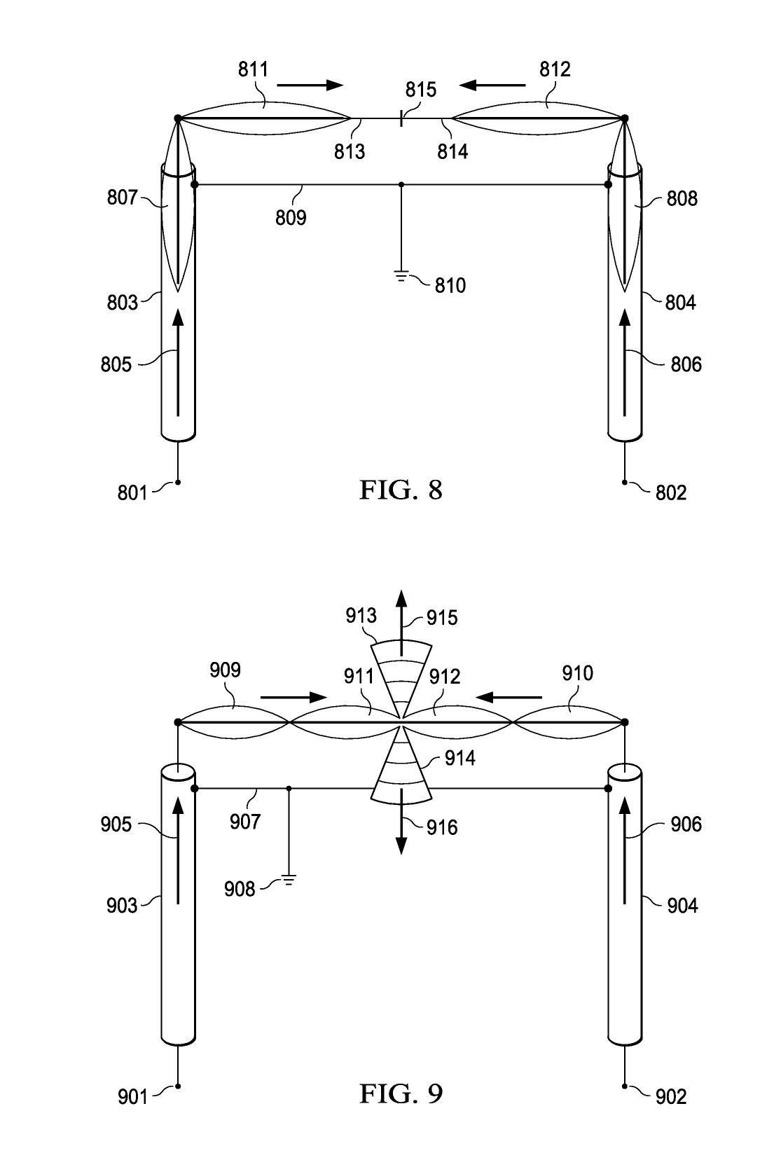

FIG. 8 shows the position of the traveling sine-wave charges at time t₂=t₁+Δt_{b}. Once again, the stereo signal from RF power amplifiers may enter the transmission lines 803 and 804 at points 801 and 802 and may travel in directions 805 and 806. The first halves of the sine wave charges of opposite polarities 811 and 812 entered the antenna wires 813 and 814 and travel toward the substantial center point 815 of the antenna wires 813 and 814. The trailing halves of sine wave charges of opposite polarities 807 and 808 are shown in their position. The wire 809 connecting the transmission lines may be grounded at point 810 which may be the substantial center of the wire 809.

FIG. 9 shows the colliding position or cooperating position of the traveling sine-wave shaped charges of opposite polarities at time of their arrival t₃=t₂+Δt_{c}. Stereo signals may be applied to transmission lines 903 and 904 at points 901 and 902. The sine-wave shaped charges may travel in directions 905 and 906 and collide at the center. The colliding sine-wave halve charges of opposite polarities 911 and 912 are illustrated as colliding at the center. The second halves of traveling sine-wave shaped charges are shown as 909 and 910. During the collision the charges may be annihilated and may be converted into the free-space wave. The free-space wave may leave the antenna in a substantially discuss shaped pattern or a substantially cone shaped pattern highlighted by numbers 913 and 914 and travel in a substantially truncated circular pattern shown by arrows 915 and 916.

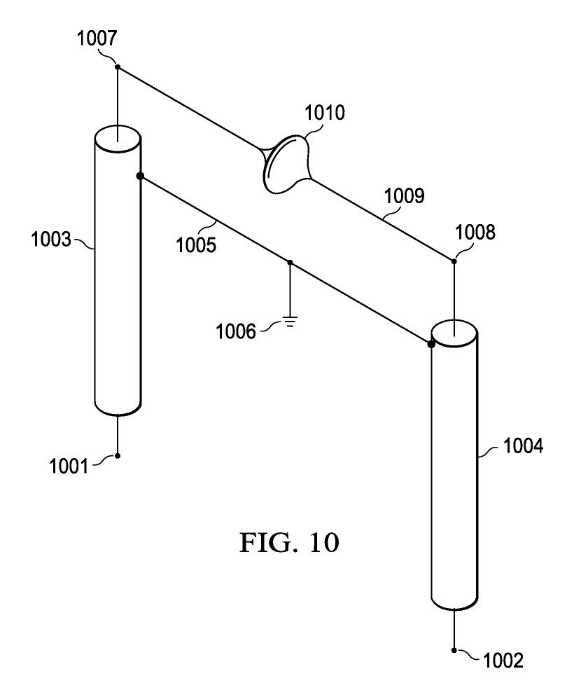

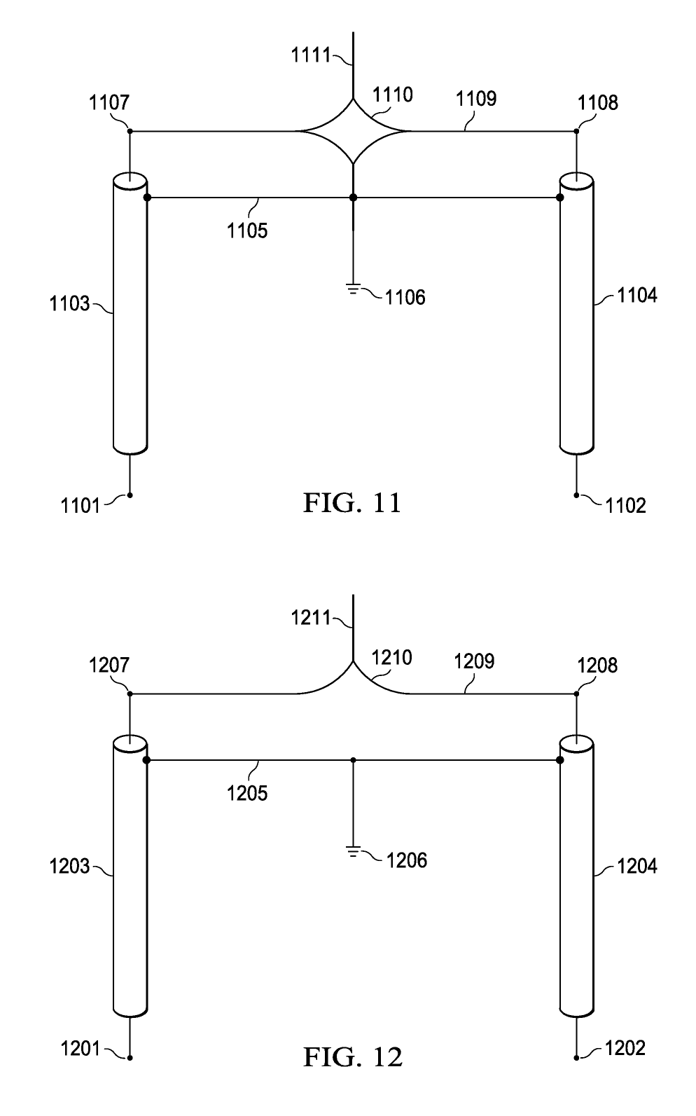

Referring to FIG. 10, another embodiment of the invention is shown. The antenna may operate like the one in FIG. 9 except for the element 1010 in the center of the antenna which may provide signal concentration. Center element 1010 in FIG. 10 is the same element as element 1110 in FIG. 11 which shows the concentrated free-space wave as 1111 and which may be a narrow discus or which may be a pair of opposed facing cones.

Referring now to FIG. 12, yet another embodiment of the invention is shown. The antenna may operate like the one presented in FIGS. 9,10,11 except for the antenna center element 1210 which may focus the free-space wave into a narrow collimated beam 1211.

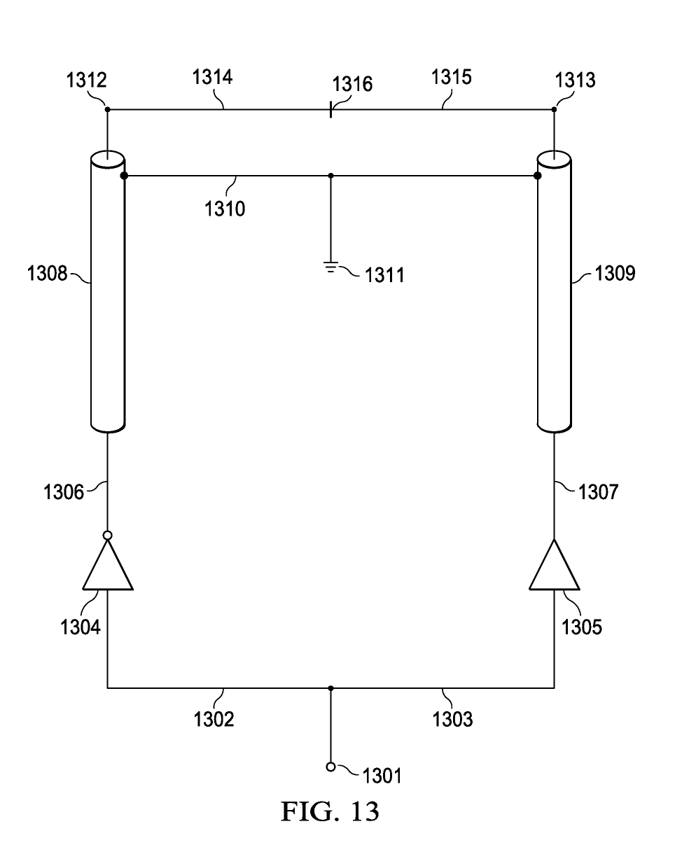

FIG. 13 shows the electrical diagram with the antenna. The RF input signal may be fed into a common terminal 1301 and may be connected to two amplifiers 1304 and 1305. Amplifier 1305 may act as a non inverting amplifier while the amplifier 1304 may invert the input signal. The signal exiting the inverting amplifier 1304 and the signal leaving the non inverting amplifier 1305 may be synchronized without any appreciable time skew in order to arrive substantially simultaneously to the center point 1316. The two signals travel via the transmission lines 1308 and 1309 and enter two branches of the stereo signal fed antenna 1314 and 1315 at points 1312 and 1313 simultaneously.

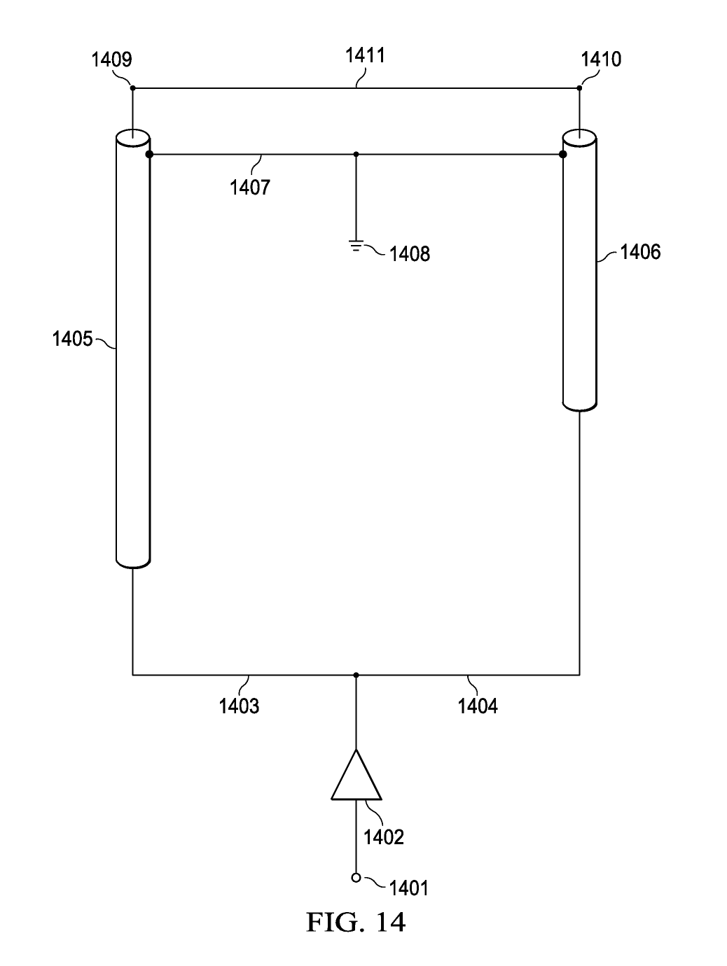

FIG. 14 illustrates yet another embodiment of the invention where the signal polarity inversion may be accomplished by delaying the traveling time of the signal by one halve of the cycle. By extending the length of the transmission line by ½, the traveling charge in the elongated transmission line 1405 may be delayed by 180° and by the time the signals from the transmission lines 1405 and 1406 arrive onto the antenna wire 1411, their polarities may be inverted. And as in previous examples, the transmission lines may be connected with wire 1407, which may be connected to the ground point 1408.

The general purpose of the present invention, which has been described subsequently in detail, is to provide a structure of high efficiency antenna mentioned heretofore and many features that result in a structure which provides performance and efficiency not anticipated, rendered obvious, suggested, or even implied by any of the prior art either alone or in any combination thereof.

Although the invention has been described in terms of its preferred embodiments, it should be understood that many modifications may be made without departing from the spirit and scope of the invention, as is recited in the claims which follow.

1) An antenna system for transmitting a signal, comprising:
a traveling wave antenna having a first conductor and a second conductor;
the first conductor being positioned at an acute angle with respect to the second conductor;
a transmission line coupled to the first conductor and the second conductor.

2) An antenna system for transmitting a signal as in claim 1, wherein the acute angle depends on the length of the first conductor and the second conductor.

3) An antenna system for transmitting a signal as in claim 1, wherein an first end of the first conductor and an second end of the second conductor is connected to a first resistor and a second resistor.

4) An antenna system for transmitting a signal as in claim 3, wherein the first resistor is substantially equal in magnitude to the second resistor.

5) An antenna system for transmitting a signal as in claim 1, wherein the first signal is a sinusoidal wave form.

6) An antenna system for transmitting a signal as in claim 1, wherein the signal is substantially a square wave form.

7) An antenna system for transmitting a signal as in claim 1, wherein the signal is a non-uniform signal.

8) An antenna system for transmitting a signal as in claim 1, wherein the signal is a nonsymmetrical signal.

9) An antenna system for transmitting a signal, comprising:
a resonant dipole antenna having a first conductor and a second conductor;
the first conductor being positioned at a substantially 180° angle with respect to the second conductor;
a transmission line coupled to the first conductor and the second conductor.

10) An antenna system for transmitting a signal as in claim 9, wherein the length of the first conductor and the second conductor is substantially is λ/2.

11) An antenna system for transmitting a signal as in claim 9, wherein the first signal is a sinusoidal wave form.

12) An antenna system for transmitting a signal as in claim 9, wherein the signal is substantially a square wave form.

13) An antenna system for transmitting a signal, comprising:
the signal having a first portion and a second portion
an antenna having a first conductor and a second conductor;
the first conductor being connected to receive the first portion of the signal and the second conductor being connected to receive the second portion of the signal;
a first transmission line coupled to the first conductor to conduct the first portion of the signal and a second transmission line coupled to the second conductor to conduct the second portion of the signal;
wherein the first conductor is connected to the second conductor at a substantial center point of the first conductor and the second conductor.

14) An antenna system for transmitting a signal as in claim 13, wherein the first and second transmission line are connected to a common ground.

15) An antenna system for transmitting a signal as in claim 14, wherein the common ground is centrally located between the first and second transmission line.

16) An antenna system for transmitting a signal as in claim 14, wherein the first conductor and the second conductor are connected at a substantially center recombination point

17) An antenna system for transmitting a signal as in claim 13, wherein the first portion is a first sign-wave shaped signal and the second portion is a second sine-wave shaped being of opposite polarity to the first sine-wave shaped signal.

18) An antenna system for transmitting a signal as in claim 16, wherein the first conductor and the second conductor are connected at the substantially center recombination point for signal concentration.

19) An antenna system for transmitting a signal as in claim 16, wherein the first conductor and the second conductor are connected at a narrow discus.

20) An antenna system for transmitting a signal as in claim 16, wherein the first conductor and the second conductor are connected at a pair of opposed facing cones.
